(19) United States
(12) Patent Application Publication
(10) Pub. No.: US 2003/0139210 A1
(43) Pub. Date: Jul. 24, 2003

(54) Computer-based acrostic puzzle for indiviual play and multi-player competition

(76) Inventor: Joseph Raben, New York, NY (US)

Correspondence Address: Joseph Raben, 3 Abby Road, Barrington, RI, 02806, US

(21) Appl. No.: 10/051,655

(22) Filed: Jan. 22, 2002

(51) Int. Cl. A63F 13/00

(52) U.S. Cl. 463/9

(57) ABSTRACT

The acrostic puzzle of this invention is designed for play on computer-based devices or interactive television, with optional animation, optional sound effects, and a system of scoring based on assigning values to the letters of the alphabet. When all the clues have been successfully solved, a quotation using the same letters appears in a grid. In individual play or competition over a computer network, a player seeks to achieve the highest score by first entering letters into spaces adjacent to a column of clues and then, as the words of a quotation begin to form in the grid, by entering additional letters into the grid. As a television game show, the puzzle of the invention may be played, according to rules devised by the promoters of the game show, by several players, including one or more outside the studio, participating by means of their home computers or other appropriate devices.

### CROSS REFERENCE TO RELATED APPLICATIONS

U.S. Pat. No. 5,921,864 Jul. 13, 1999 Walker, Jay S. Electronic puzzle game Distinctions between the referenced patent and the present invention:

the puzzle in the referenced patent is based on a word puzzle in which the players guess at the required letter, whereas my invention is based on an acrostic puzzle which includes clues for each word,

my invention is designed not only for individual entertainment, like the referenced patent, but also for use as a television game show, for play on an electronic book (e-book), or as an instructional tool;

in ordinary play with my invention there are no time limits on the player, as there is in the referenced patent;

in my invention scores are built up rather than being deducted from a base score provided at the beginning of play, as they are in the referenced patent;

in my invention, the player or players may play against the program itself.

### BACKGROUND OF THE INVENTION

This invention derives from the acrostic puzzles published since the 1930s in major magazines and newspapers. In that print form, the individual player inserts letters above numbered dashes in response to clues provided and then transfers those letters to correspondingly numbered squares in a grid which resembles that of a crossword puzzle. After some letters are entered into the grid, incomplete words may be completed; these letters are then copied to the numbered dashes to help complete the clue words. When the puzzle is completed, the grid contains a quotation, and the initial letters over each of the filled-in dashes read vertically, spell the author of the quotation (and sometimes its source).

In the currently available computer-based form, the transfer of letters, both from the clues column to the grid and vice versa, is automatic and the dashes are replaced by squares. The invention for which application is being made further enhances the enjoyment of this type of puzzle by providing for multi-player participation on television, or over the Internet or similar network, thereby creating a new mode of entertainment for both individual players and for a large television audience, which can either observe the play that originates in a studio or participate in it through their computers.

Prior art consists of earlier efforts to create computer programs that allow individual players to complete acrostic puzzles on a computer. The earliest that I am aware of was written by Benjamin Nobel, a young relative of mine and at that time a college sophomore. I gave him the specifications for the program as far as I had conceived it at that tme, and he wrote it in Java, with the undertstanding that we would collaborate and share any revenue to be derived. On his own and without my consent, he installed the program, first on his college server and then on a commercial Web site (www.jgames.com). It simply allowed the player to enter letters into the clues squares or the grid and accumulates a score according to the values assigned to the letters of the alphabet. Apparently, this puzzle is no longer installed on that Web site.

An essentially similar program but without the scoring facility has been written by several others: Sue Gleason, who has posted hers on a Web site (www. doublecrostic com); David Howorth (www.teleport.com/^{˜}howrth/e-crostic); John V. Holder (www.northcoast.com/^{˜}jvholder); and Sheila Haak (www.members. aol.com/acrostics). Gleason's version, which contains several features that I suggested during a period when we were trying to work out a collaboration, is primarily intended to allow the player to download and print several puzzles to be completed on paper. Another one written by Samuel Bellotto, which he calls EnigmaCross, is essentially the same as the ones just described, but is somewhat more sophisticated in the section that facilitates construction of the puzzles. Mr. Bellotto's program (available at www.crossdown.com) could be upgraded, under license, to support the functions covered in this patent application.

None of the currently available programs contains the following elements, which are unique to the invention for which a patent is being sought:

a. the assignment of point values to the individual letters constituting the quotation, the doubling of all values in successive iterations of the game, and the subtraction of points for incorrectly guessed letters,

b. the evolution of the puzzle into a competitive quiz show, or the exhibition of such a competitive quiz show on broadcast, cable or interactive television,

c. the evolution of the puzzle into an entertainment or competition on a personal digital assistant (with or without wireless connection) or on an e-book,

d. the use of movable tiles on the computer screen, and th eillusion of the tiles moving from the letter tray to positions in the grid and the clues,

e. the optional use of animated cartoons to transport the tiles,

f. the option to play against the program itself,

g. an optional program to consult a database comprising at least two types of information, namely demographic details about the player (age, gender, geographic region, professed interests, etc.) and the record of that player's prior performance when playing the game, in order to adjust such factors as the topic on which the quotation and the clues are based and the level of the puzzle's difficulty. a “Lucky Letter,” which is not revealed to the player(s) until it is selected and for which a player who enters that letter will receive a bonus of points.

My invention derives from Scrabble® the concept of assigning a point value to each letter according to its relative frequency in spelling words. Distinguishing my invention from Scrabble® (in addition to the fact that Scrabble® is based on crossword puzzles, whereas this invention is based on acrostic puzzles) is the capability of increasing the value of letters entered into the grid, where there are no clues, so that they can be worth double or more of the value of those entered into the clues column. The player or players of my invention can therefore strive to achieve the highest possible score by guessing words as they are partly formed in the grid by the letters transferred from the clues. The player or players can be penalized for wrong letters by having the value of those letters deducted from the running score. A single player has the option of playing aginst the program. And in a multi-player version on television, the values can be doubled for each of successive iterations of the game to increase audience excitement and to raise the value of the prizes or awards based on each player's score.

When played as a television game show, my invention allows members of the viewing audience to participate over the Internet or similar network, with the player first achieving the highest score having his/her score recorded on the television screens and the computer screens of viewers who are logged on. As an alternative mode of play, the players can cooperate to achieve a higher score than any of them might achieve alone. This mode of play might be especially attractive to people who enjoy collaborative work more than competitive.

### BRIEF SUMMARY OF THE INVENTION

My invention is an online, interactive, enhanced version of a conventional acrostic puzzle, intended for individual or multi-player interaction on a spectrum of microprocessor devices, from personal digital assistants (PDAs) to desktop computers. Puzzles can be stored on internal storage devices, downloaded in a group, downloaded individually, or played remotely from a central server.

One potential enhancement of this invention is to derive the quotation from a book or other source that relates to a special interest, such as gardening, art, golf, or African American culture. Players can be invited to follow links from the puzzle to the vendors of products related to those interests or to books dealing with them.

As a marketing service, each puzzle can be hyperlinked to the Web sites of appropriate merchants. Hyperlinks can also be used to provide non-verbal clues, such as reproductions of art works or brief musical selections. As an instructional tool, my invention can be used, for example, for foreign-language instruction.

Accordingly, several objects and advantages of my invention are to enhance existing online acrostic games by adding a system of scoring that allows competitive play, over computer networks through programs stored on computers of any size, and through interactive television.

Other objects and advantages include the use of letter tiles that may appear to move over the screen, the use of animated characters which appear to carry the tiles, the use of sound effects to increase the pleasure of playing the game, the use of a “Lucky Letter” in the television game-show mode, to increase the excitement of the game, and enlarging the displayed faces of each player in turn.

Further objects and advantges of my invention will become apparent from a consideration of the drawings and ensuing description.

### BRIEF DESCRIPTION OF THE SEVERAL VIEWS OF THE DRAWINGS

FIG. 1 shows the opening screen of a puzzle as it would appear on a personal digital assistant (PDA):or similar device.

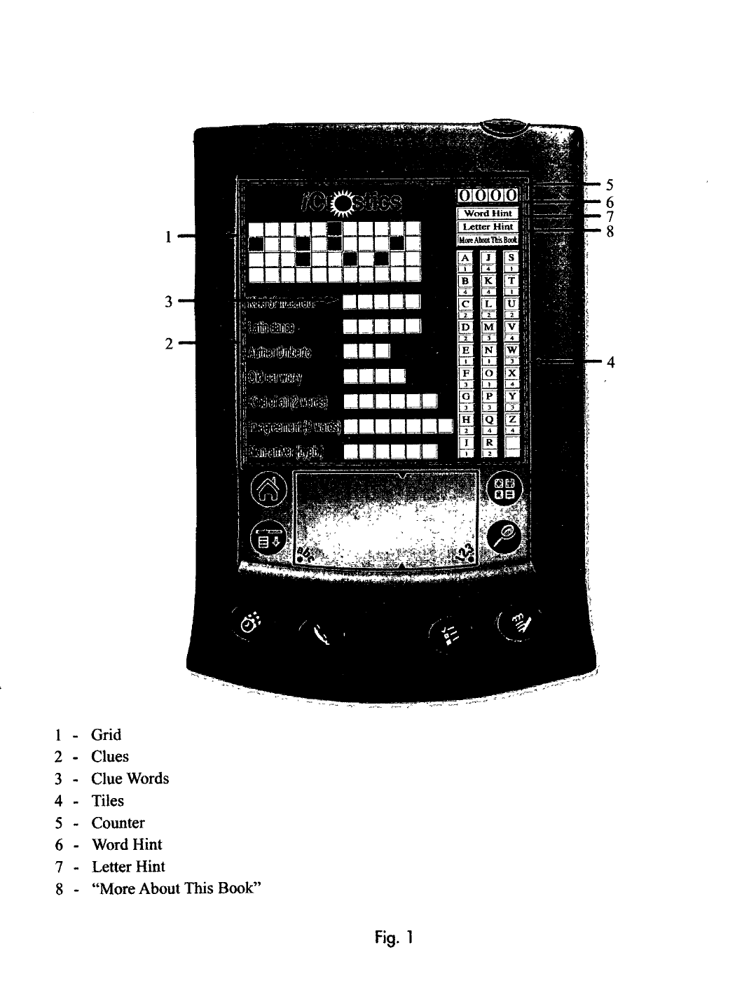

1 Grid

2 Clues

3 Clue words

4 Alphabet tiles with point values

5 Score counter

6 “Word Hint” button

7 “Letter Hint” button

8 Optional “More About This Book” button

FIG. 2 shows said opening screen enlarged.

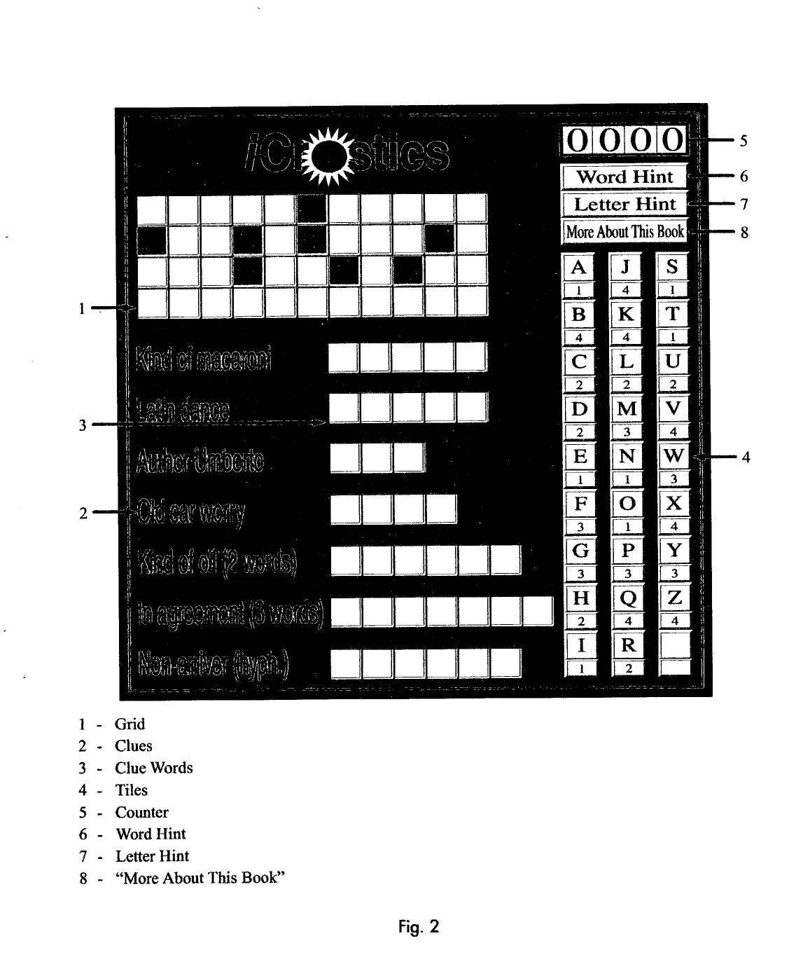

FIG. 3 shows how the program outlines a square that relates a letter in said clues with its corresponding letter in said grid when the player positions a screen pointer, stylus or other means of selection over a square in either said clues or said grid. The player then enters the appropriate letter (M).

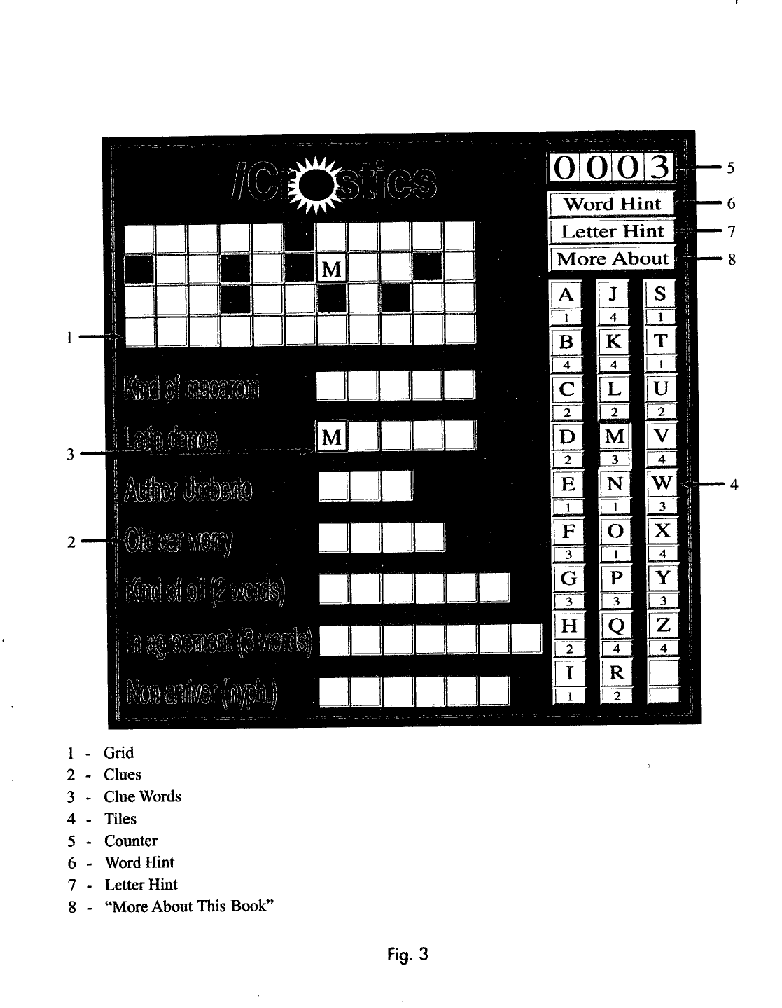

FIG. 4 shows an entire word (MAMBO) entered by a player into said clues with its letters appearing in their appropriate positions in said grid. The score (12) calculated by the progam for those letters appears.

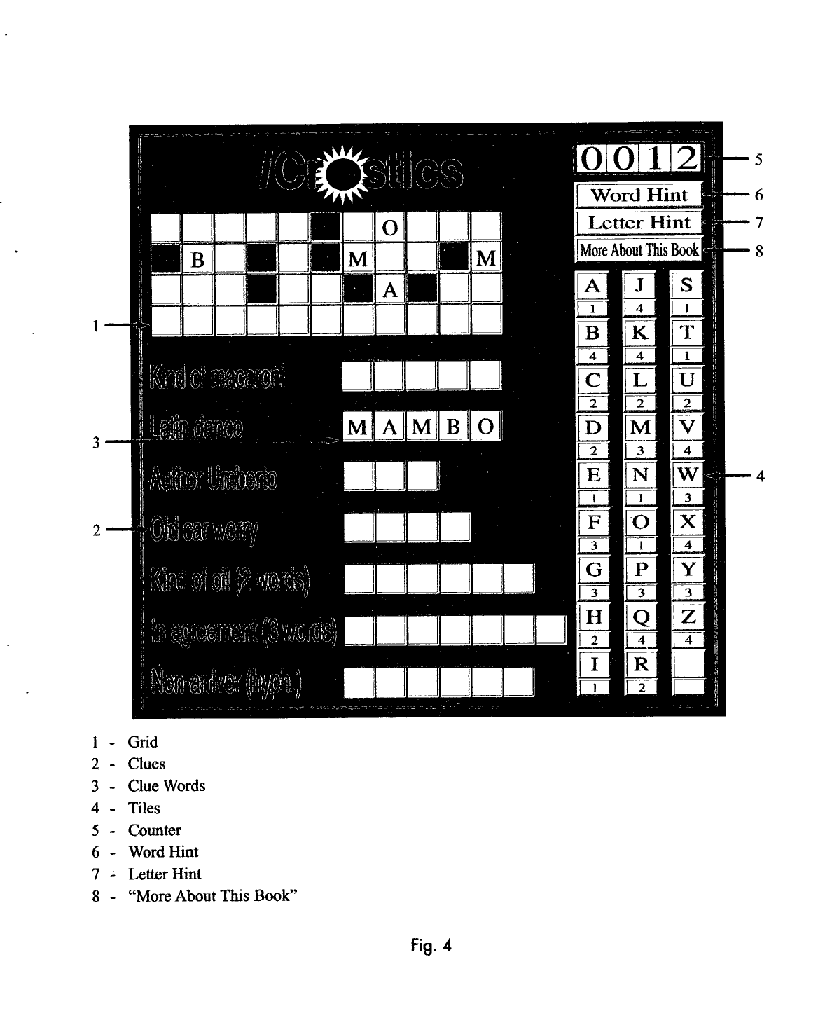

FIG. 5 shows the next letter square selected by the player in said clues and the position of its corresponding letter in said grid. The letter S has been entered by the player.

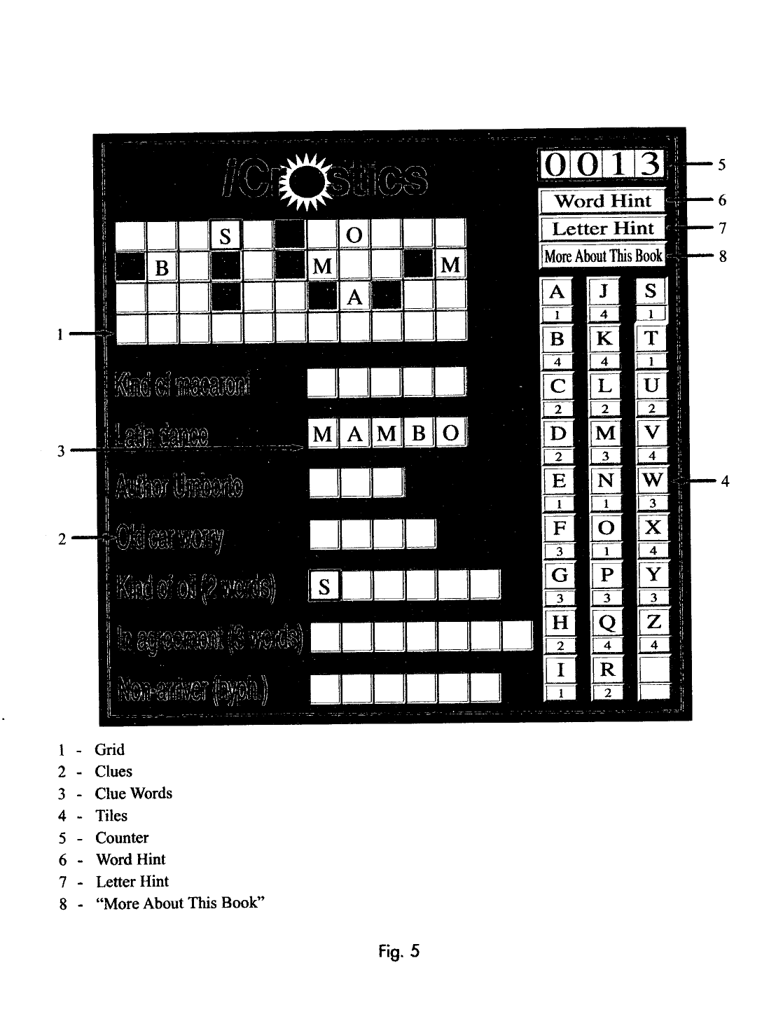

FIG. 6 shows another entire word (SUNTAN) entered by a player into said clues with its letters appearing in their appropriate positions in said grid. The score has been increased by the program to ·to account for those letters.

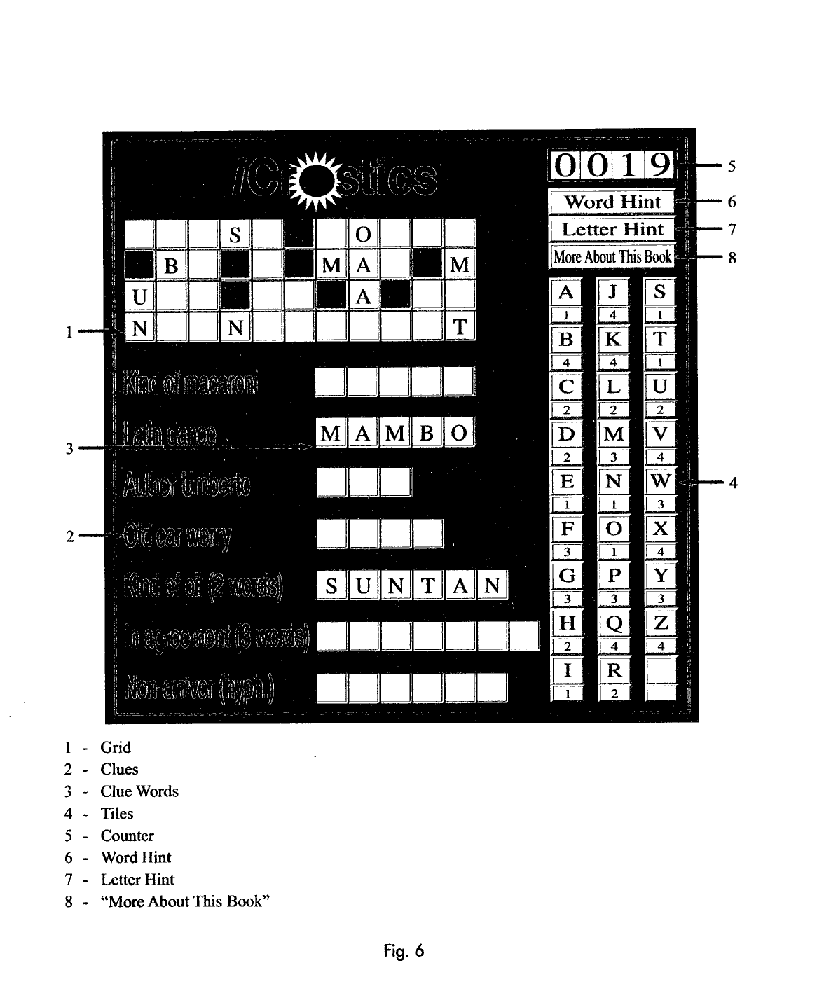

FIG. 7 shows how when the initial letter space of the fourth word is selected by a player and said “Letter Hint” button has been pressed, the letter R is supplied by the program, in both said clues and its corresponding position in said grid; the score has been reduced by two points to 17.

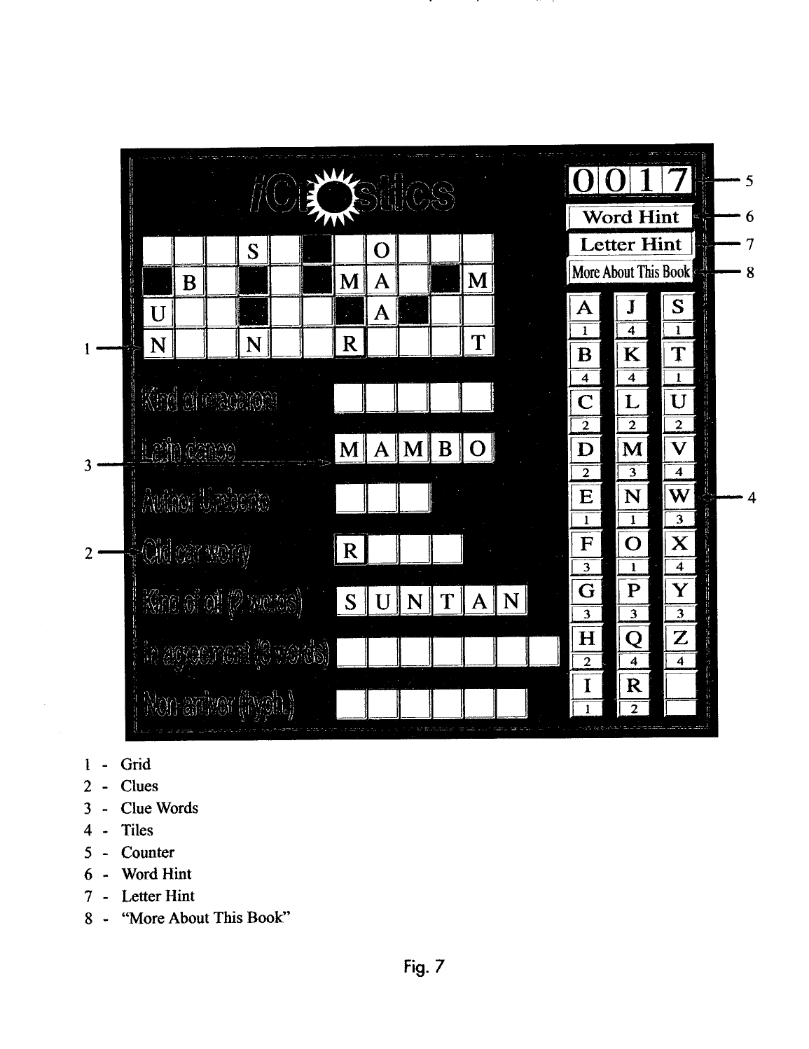

FIG. 8 shows the remaining letters of the word RUST entered by the player into said clues with those letters apearing in their appropriate positions in said grid. The score has been increased to 21 to account for those letters.

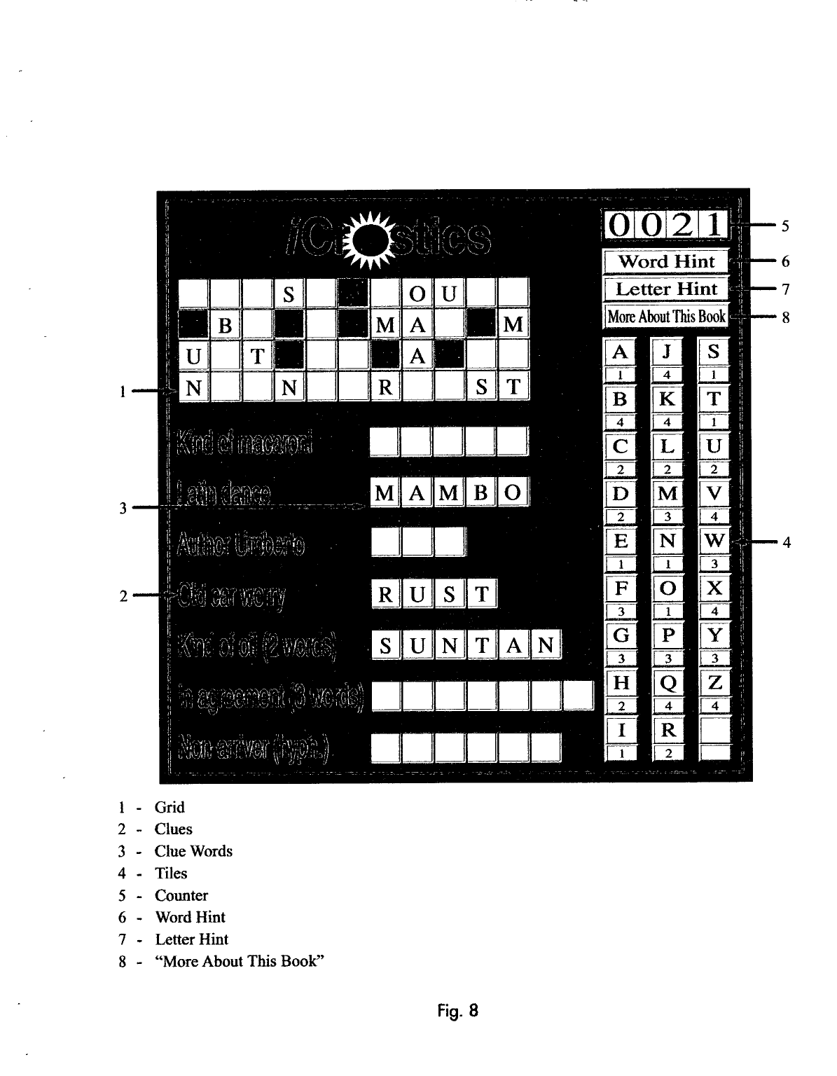

FIG. 9 shows letters (E, L, M, I, D) entered into said grid by the player and their corresponding appearance in said clues. Since letters entered into said grid by the player are worth double points, the score has been increased to 59 to account for those letters.

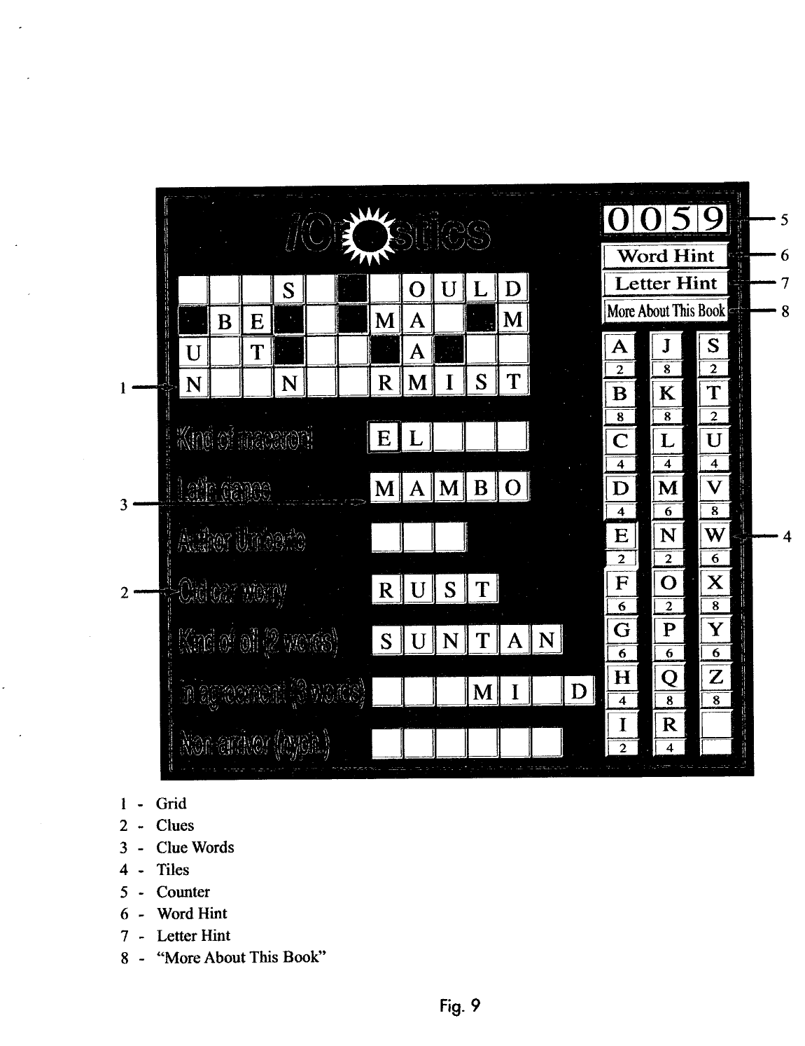

FIG. 10 shows E, O, and N entered by a player so that the initial letters of said clue words, when read vertically, reveal the author of the quotation (EMERSON); the score has been increased to to 63. (The highlighting will not appear in the actual puzzle.)

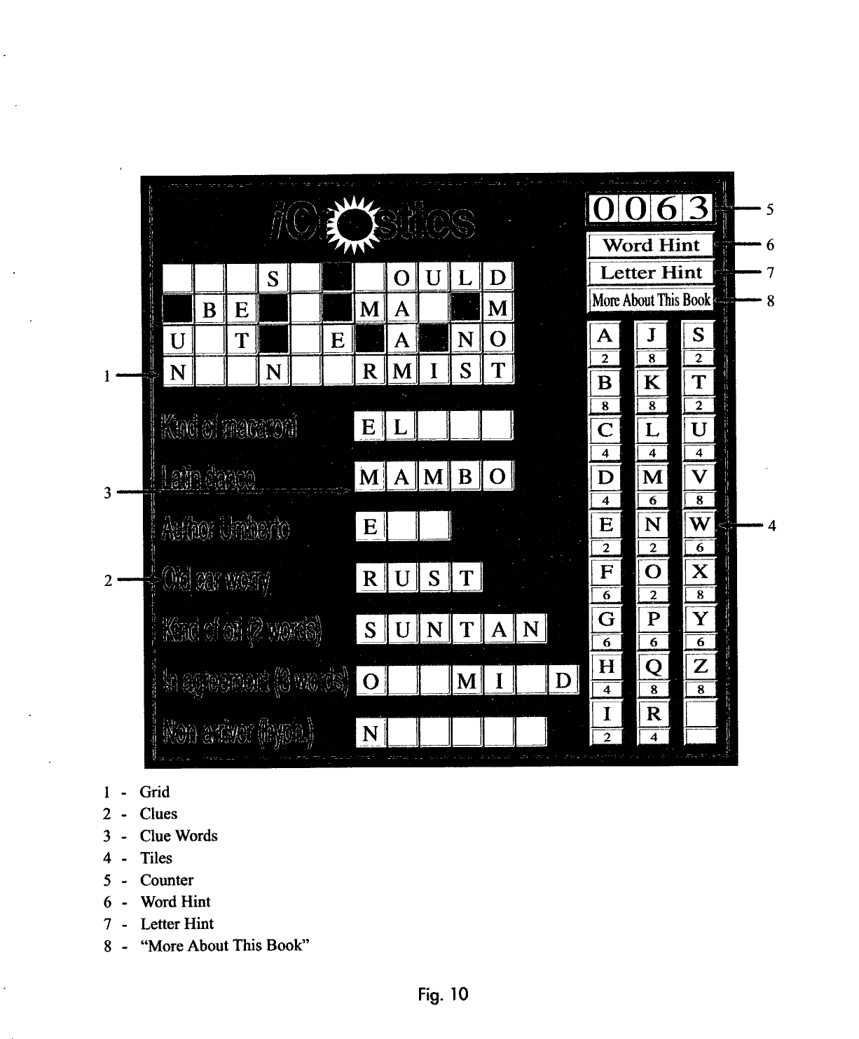

FIG. 11 shows how when the first word in said grid is selected and said “Word Hint” button has been pressed the word WHOSO is entered into said grid by the program and its letters appear in their corresponding positions in said clue words. Since letters entered into said grid are worth double points, and the values of letters entered by the program are deducted from the player's score, the score has been lowered to 35.

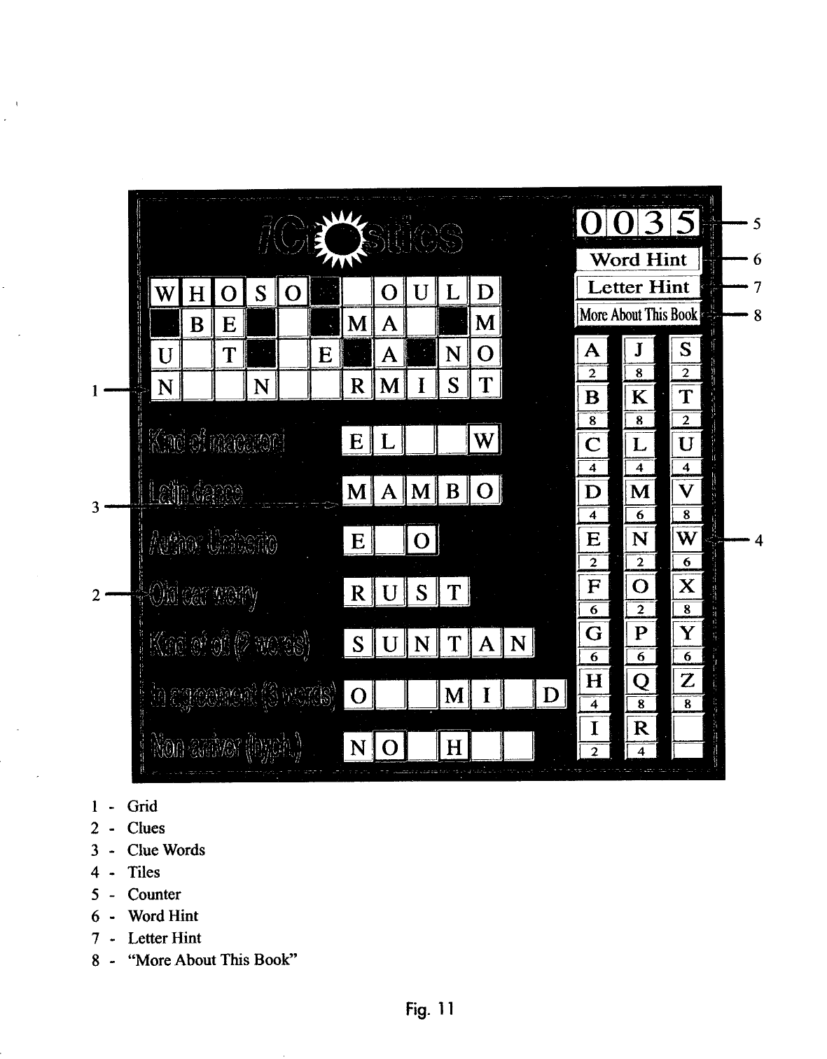

FIG. 12 shows the puzzle completed with the clues all filled in and the quotation revealed. (Since the score may be based in some measure on direct entries into said grid, which are worth twice the value of those entered into the clues, the score shown here is approximate.)

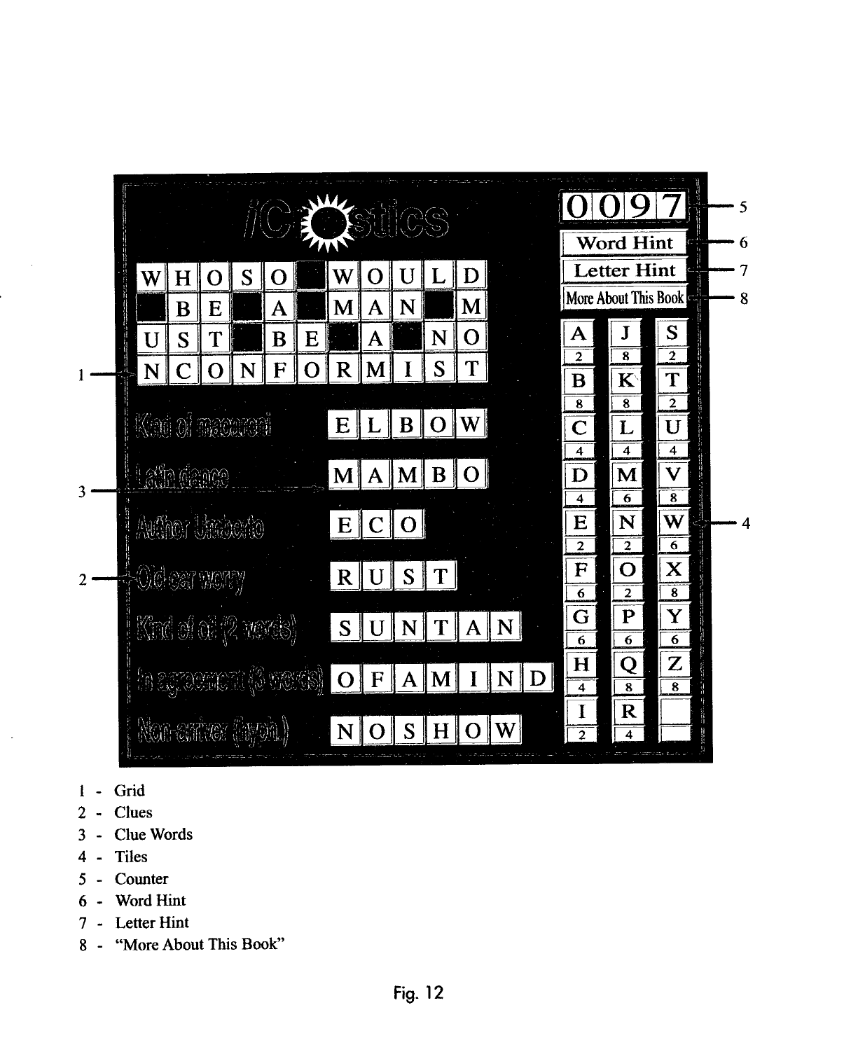

FIG. 13 shows the “More About This Book” button depressed. This action links the player's device to another Web site.

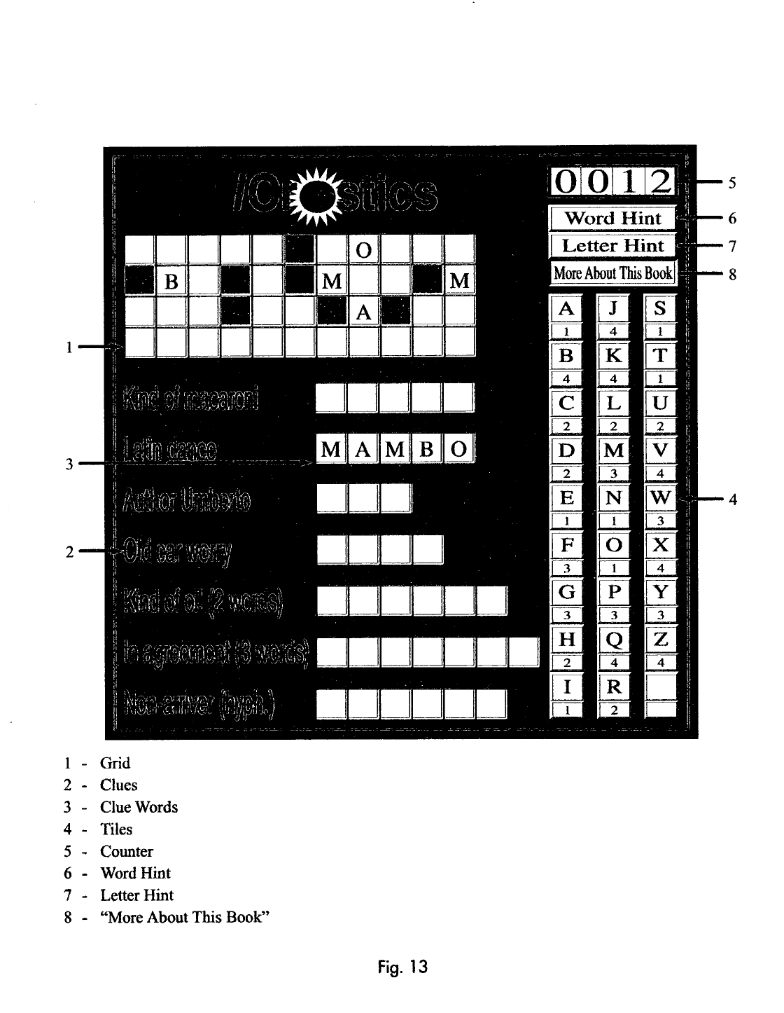

FIG. 14 shows said puzzle as it would appear on a television screen when being played as a televsion game show. The faces of the contestants (three in this instance) appear next to their scrores. The point values of the individual letters are set at an initial value. A square in a selected clue word is highlighted to correspond to its appropriate position in said grid.

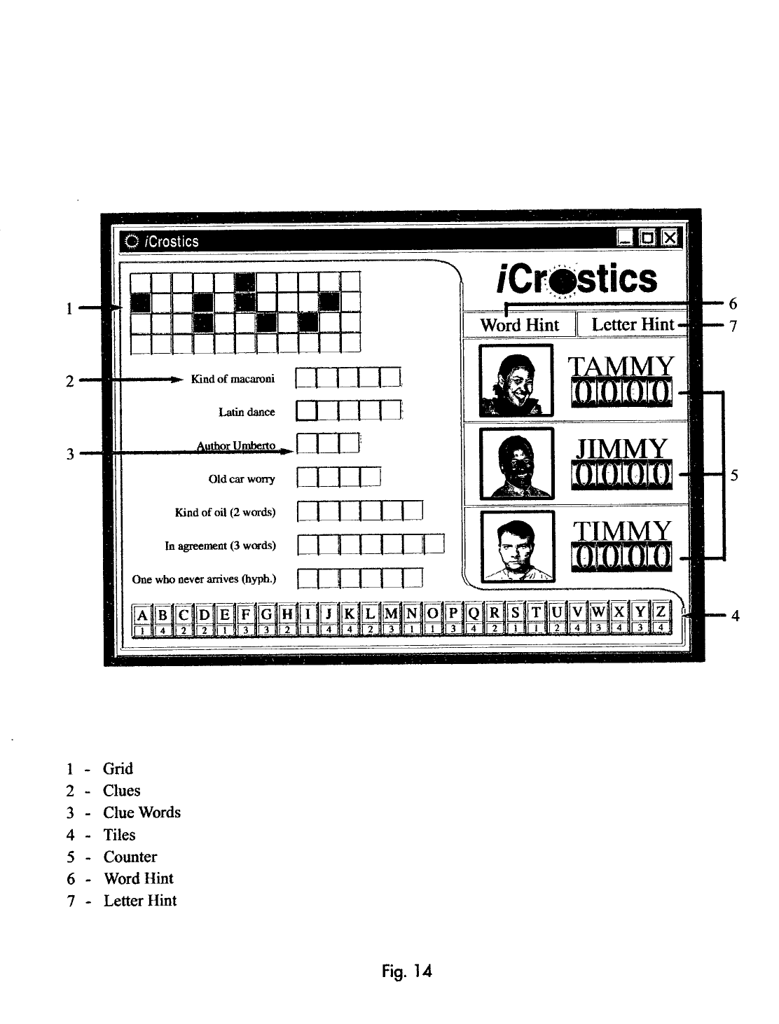

FIG. 15 shows a letter (M) being selected by a player (JIMMY). A copy of the selected letter tile moves to the chosen location while the icons move from said player's image to the same location. (Optionally, said tile may appear to be carried by an animated character.) As other players add letters in the same fashion to said clue word, their scores increase.

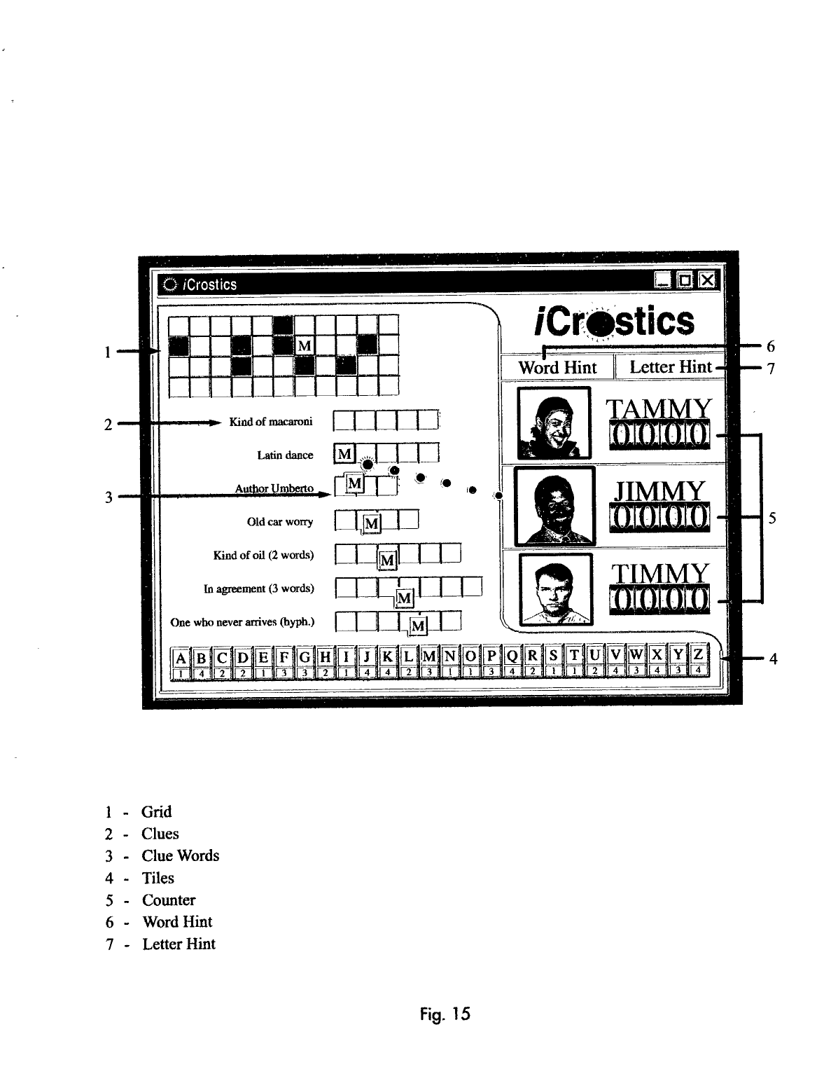

FIG. 16 shows another clue word selected with a square highlighted to correpond to its position in said grid.

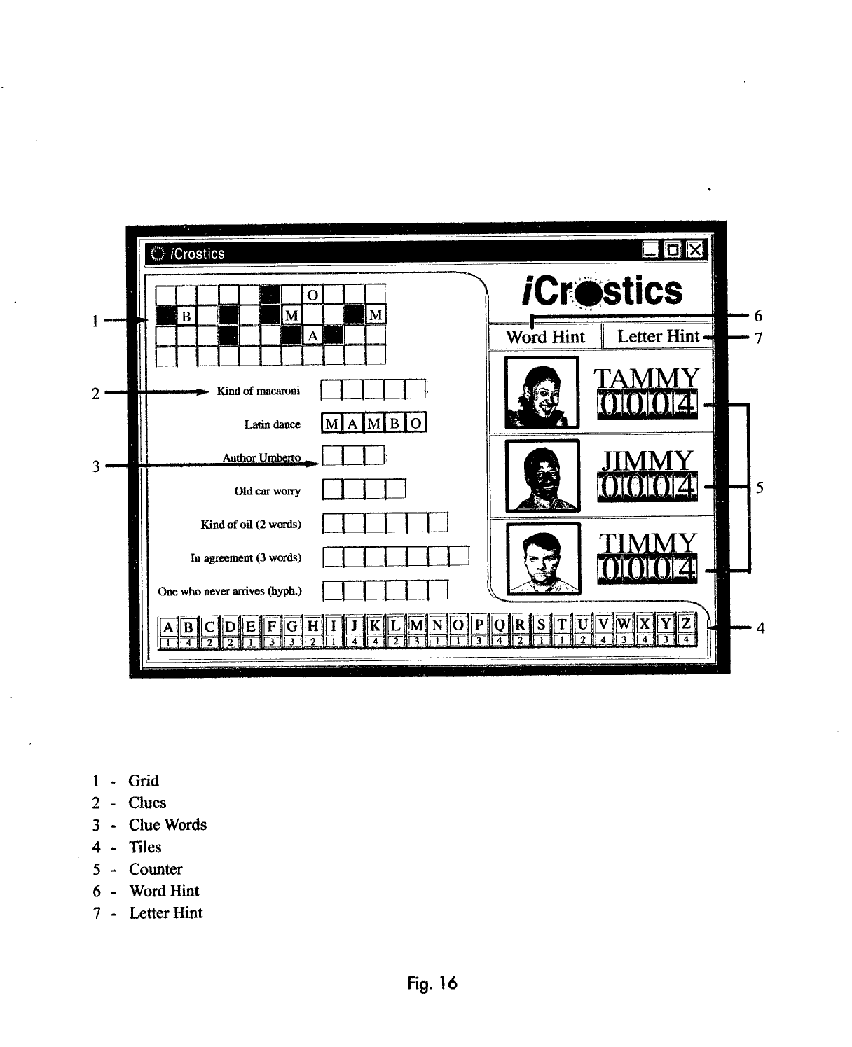

FIG. 17 shows a letter (S) being selected by a player (TAMMY). A copy of the selected letter tile moves to the chosen location while the icons move from the player's image to the same location As other players add letters to the clue word, their scores increase.

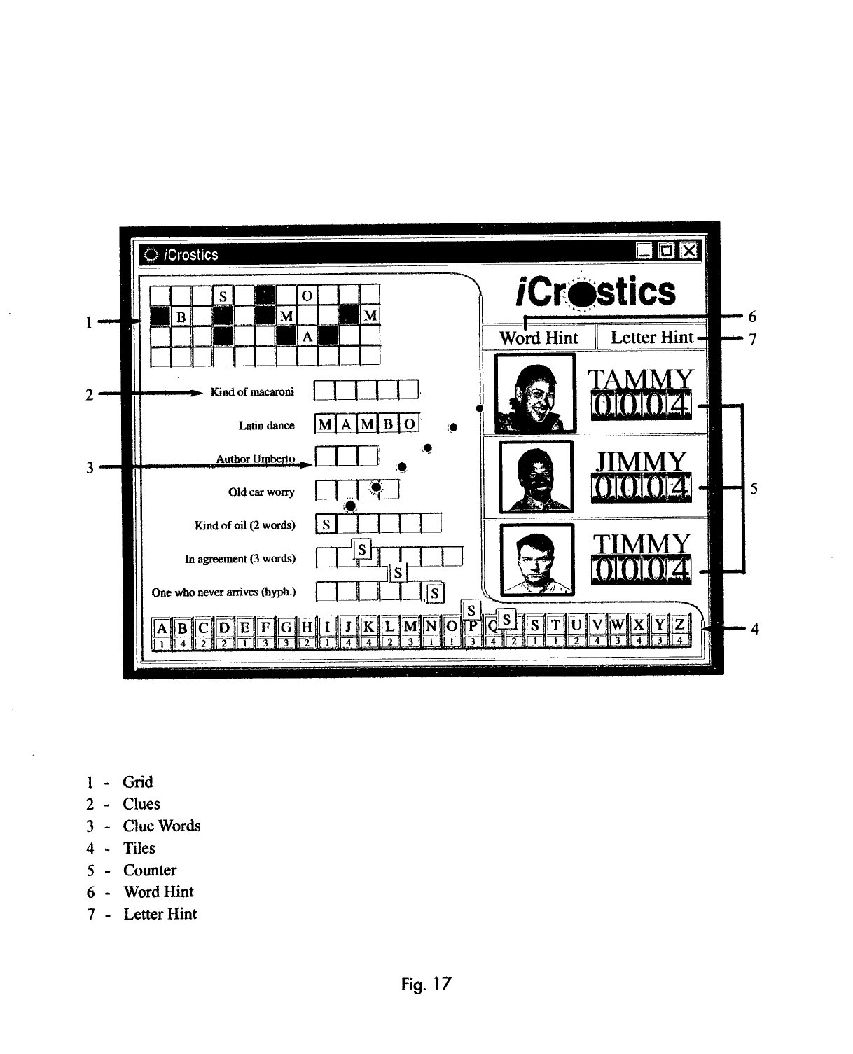

FIG. 18 shows another clue word selected with a square highlighted to correpond to its positions in said grid.

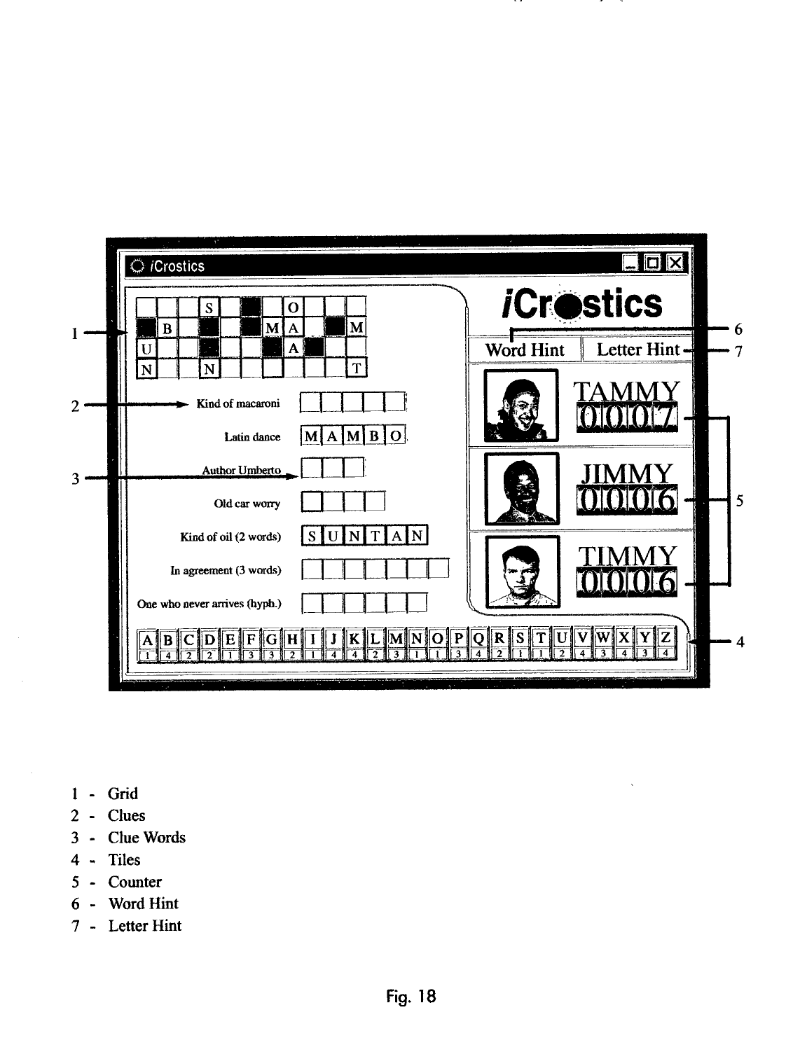

FIG. 19 shows a letter (R) being selected by a player (JIMMY). A copy of the selected letter tile moves to the chosen location while the icons move from the player's image to the same location As other players add letters to said clue word, their scores increase.

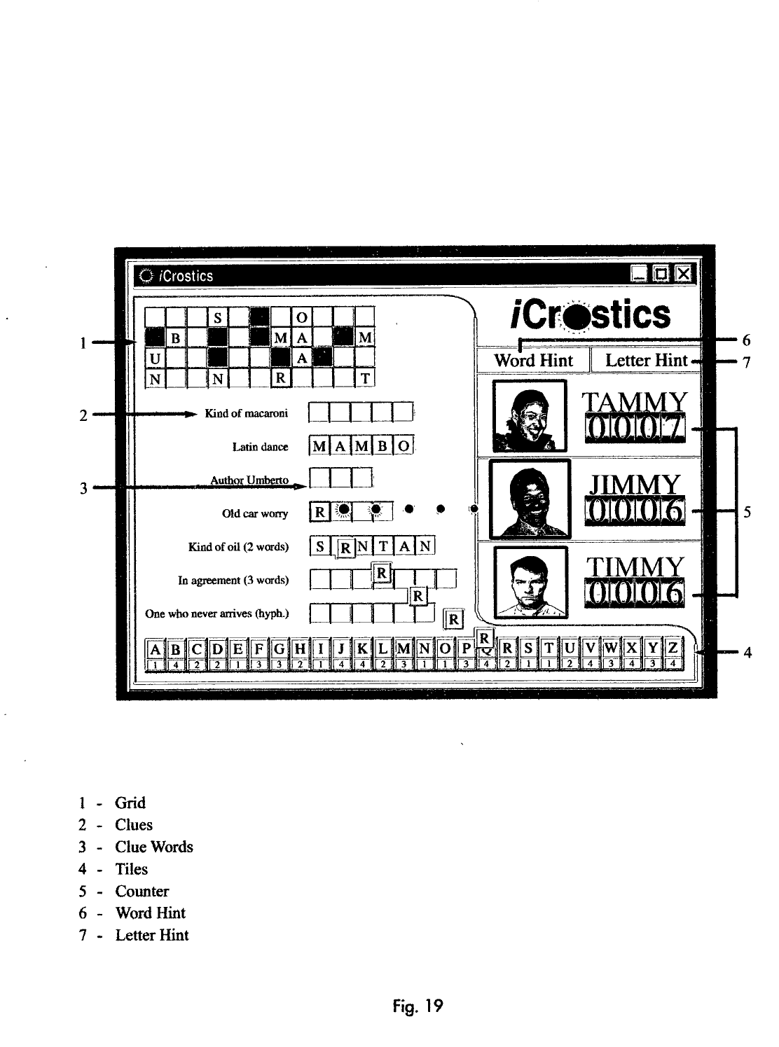

FIG. 20 shows the remaining letters of RUST entered and the scores of the players increased.

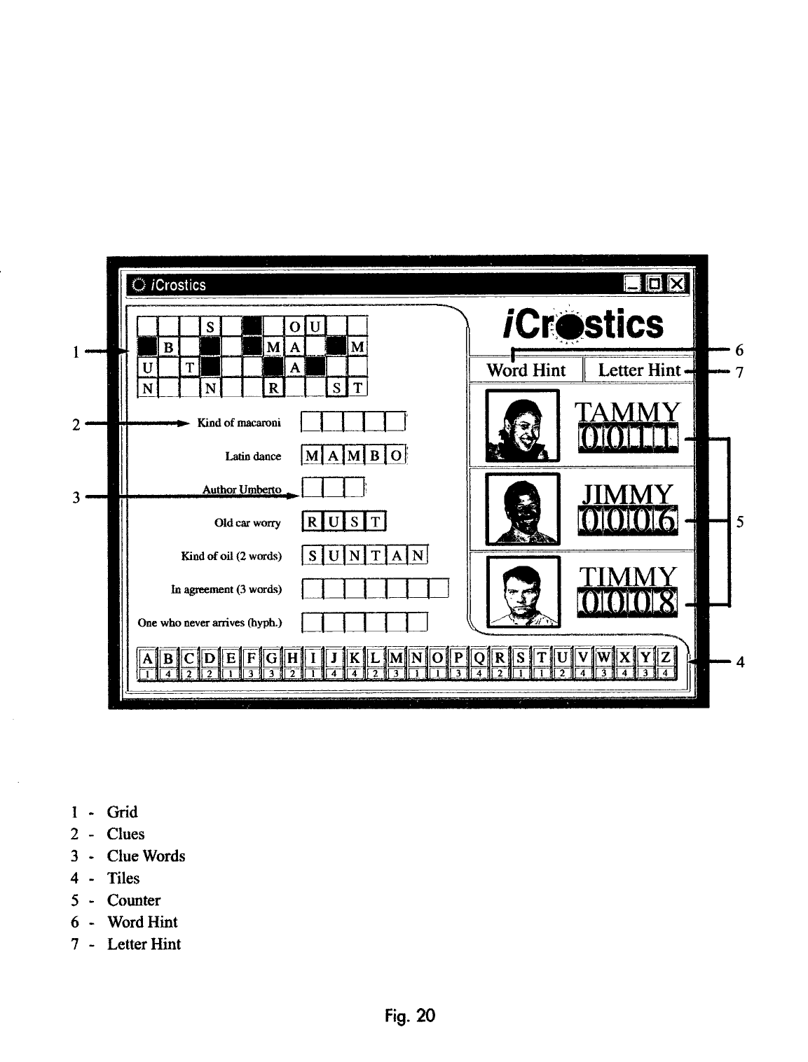

FIG. 21 shows letters (E, L, M, I, D) entered into said grid and their corresponding appearance in said clues. The scores have been increased to account for those letters.

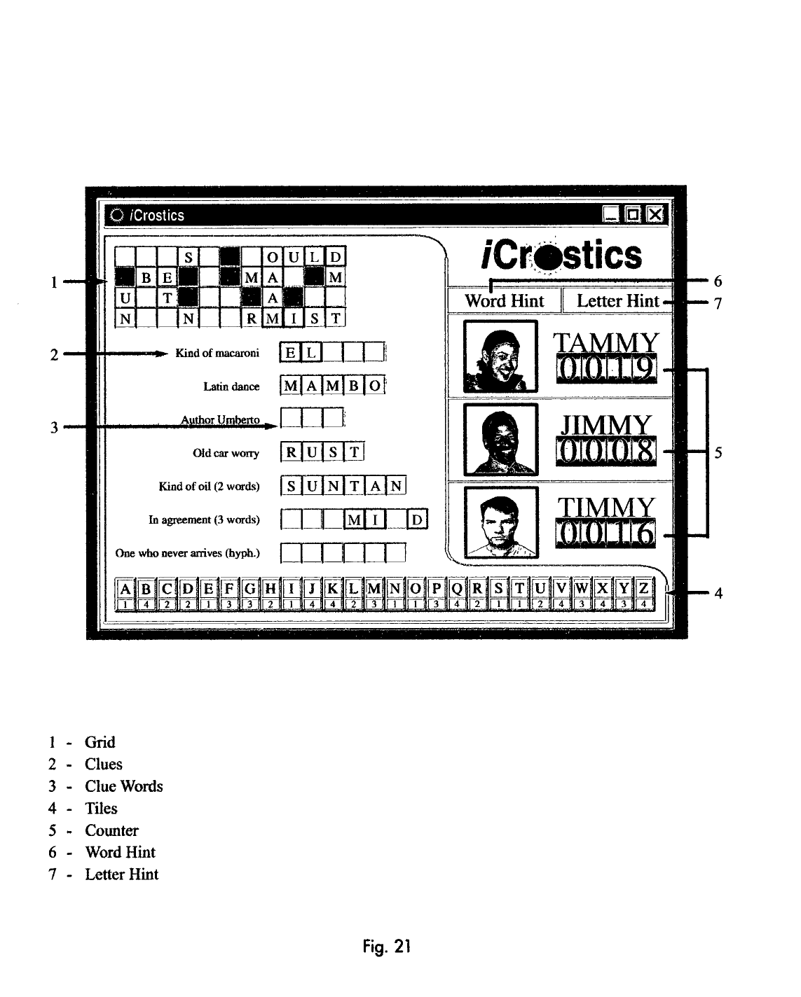

FIG. 22 shows the initial letters of the clues read vertically to reveal the author of the quotation. (The highlighting will not appear in the actual puzzle.)

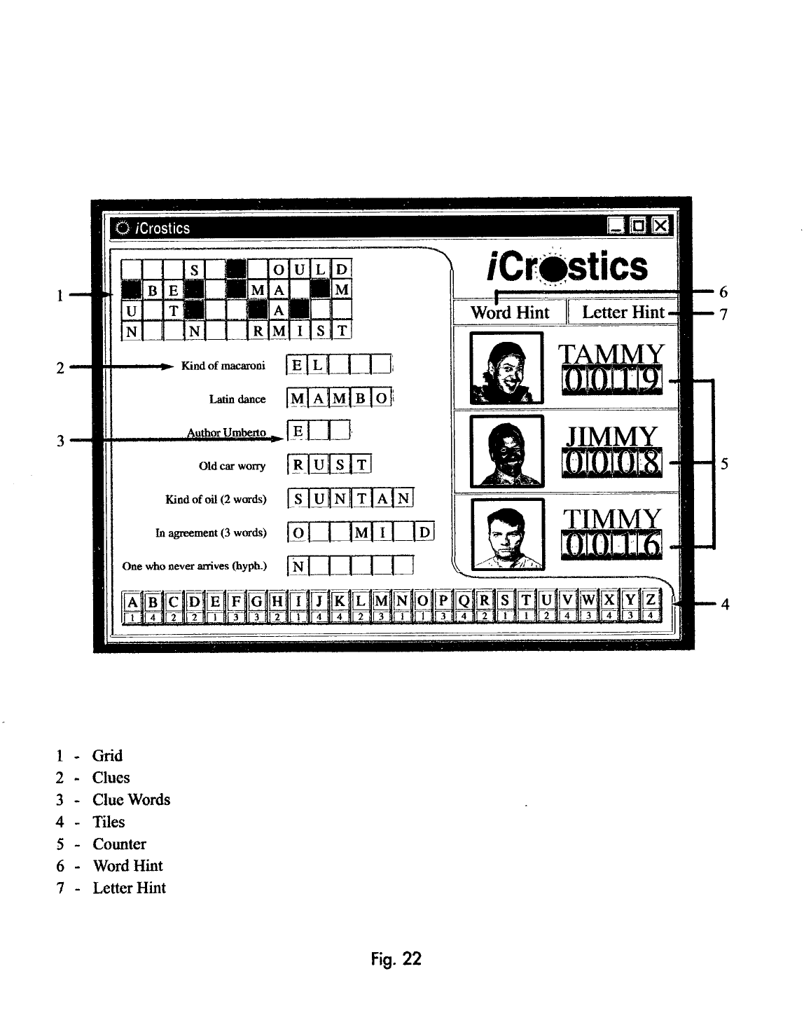

FIG. 23 shows the puzzle completed with the clues all filled in and the quotation revealed. (Since the scores may be based in some measure on entries into the grid, which are worth twice the value of those entered into the clues, the score shown here is approximate.)

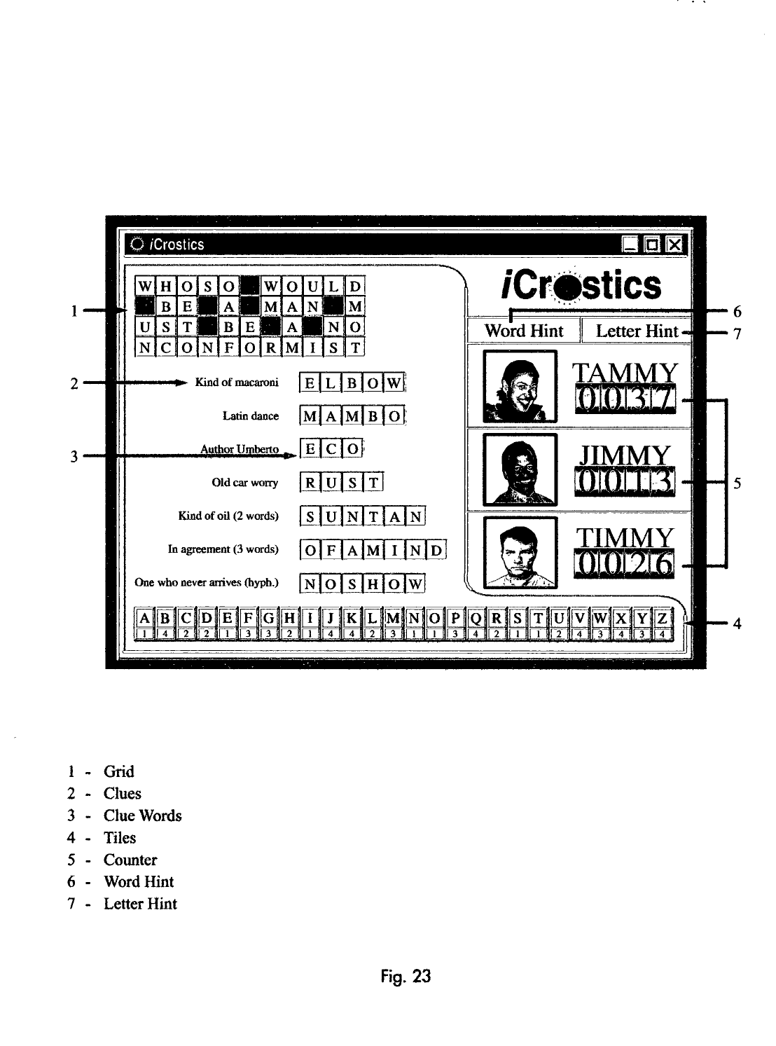

FIG. 24 shows the option of having an anonymous player from the viewing audience compete with the studio players and having that player's score recorded on the screen.

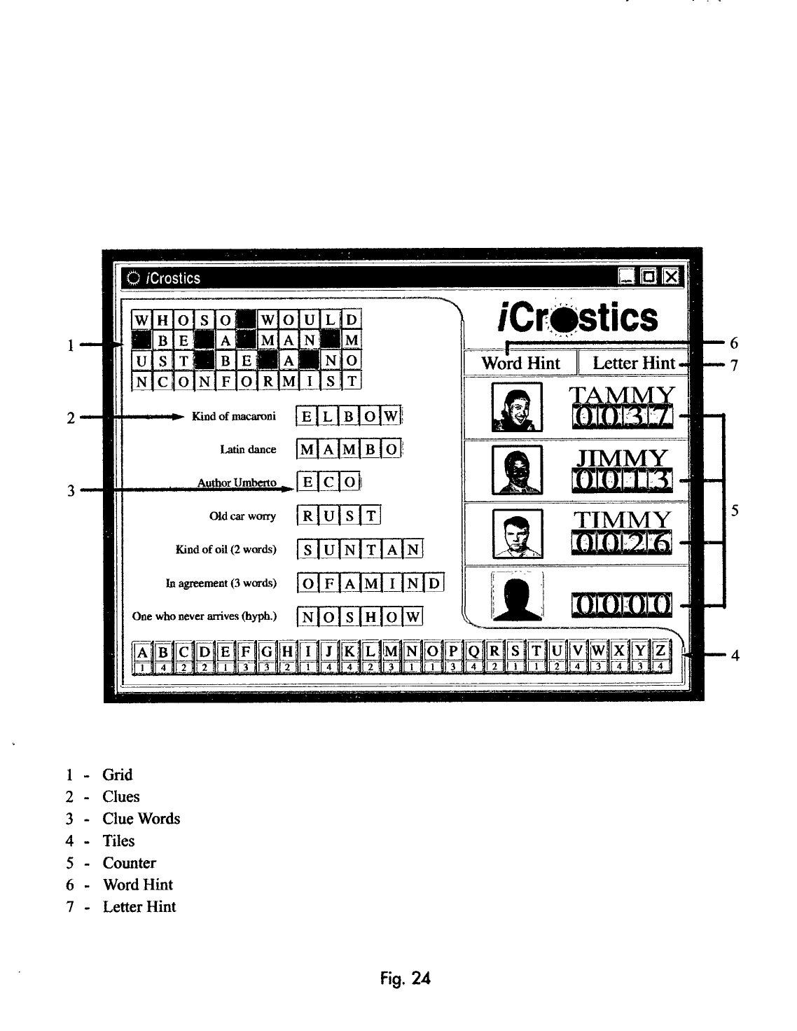

### DETAILED DESCRIPTION OF THE INVENTION

My invention is an acrostic-based electronic puzzle intended for play in several modes: as an individual entertainment, as a multi-player television contest in which the viewing audience can participate via their home computers, PDAs, e-books or similar devices, and as an instructional tool for such subjects as foreign-language instruction. It is an enhancement of the existing print version in that the speed and accuracy of electronic letter entry facilitates concentration on the content of the puzzle rather than its mechanics, while the introduction of point values for the individual letters provides opportunities to play for a high score and to compete against other players for prizes and awards. While it may, under license, use one of the existing computer programs for constructing and solving acrostic puzzles, it enhances these in several ways.

The clues and the quotation can be based on specific interests, such as gardening or golf; on cultural identities, such as African American or Asian American; or on a recent book. As a marketing service, each puzzle can be hyperlinked to the Web sites of appropriate merchants, such as (for gardening, to choose one example) the purveyors of books on gardening, garden seeds, garden tools, gardening clothes, magazines and books for gardeners, or garden tours and shows. Hyperlinks can also be used to provide non-verbal clues, as for example, reproductions of art works from one or more museum sites for puzzles with an art theme, portraits of famous golfers or views of golf courses for puzzles with a golfing theme, views of plants and flowers for puzzles with a gardening theme.

As an instructional tool, the invention for which application is being made can be used, for example, as an aid to foreign-language instruction. Clues can be provided in, say, English, with the required words in, say, Spanish; or the pattern could be reversed, with the clues in Spanish and the words in English. Thus the acquisition of vocabulary would be introduced as a corollary to the game, again either for individual play or for competition with classmates and even remote students who choose this mode of learning. As the clue word is completed, it can be pronounced several times to facilitate vocabulary acquisition. The quotation itself can be derived from texts which are appropriate for various levels of instruction. Similar puzzles can be constructed around literary classics, scientific disciplines, history, and other academic subjects.

The program underlying my invention will consist of several components: a program to be described below, a set of puzzles in memory (either stored on the player's computer or downloadable from a server) consisting of a grid, a column of clues, buttons for “Word Hint” and “Letter Hint,” a window for recording the score of each player, a means of downloading puzzles from a central source, by wireless transmission or otherwise (optional), and a means to display on a computer or similar device the letters selected. An optional “More About This Book” button can direct the player to the Web site of a bookseller.

When all the letters are correctly inserted, the grid contains a quotation reading from left to right on the consecutive lines. In contrast to a crossword puzzle, no words are formed vertically. Unique to my invention are the following: links to other Web sites, a tray of tiles bearing the letters of the alphabet and their current point values; and a means of increasing the point values of the letters being displayed. In the multi-player mode, the screen will also display the current score of each player. As a television game show, the program may also include the following capability:

at the start of play, the program will randomly select a clue and each player will enter as many letters of that word as possible;

the first player to enter a correct letter will be allowed to try to complete the word in a fixed time;

if that time elapses before the word is completed, the other players may enter any of the missing letters;

the first player to enter a correct letter is allowed to try to complete the word;

this cycle continues until the word is completed and the program randomly selects another clue.

The program consists of three components:

a. a program to present to the player or players a screen on which there appear five elements: a grid with darkened squares separating the squares in which words of the solved quotation will appear, a list of clues followed by a series of squares equal to the number of letters in the solved word, buttons for “Letter Hint,” “Word Hint,” and links to other Web sites; a counter indicating the current score of each player, and a tray of tiles bearing all the letters of the alphabet and their point values in scoring. In addition to verbal clues, the program may include visual, musical, and other types of clues.

b. a program to respond to the letters selected by each player, rejecting those that are incorrect and substracting their value from that player's running score, and placing those that are correct in their appropriate squares in both the clues column and the grid while adding their point vaue to the player's score (correct letters that are entered directly into the grid receive double the current point value of those entered into the clues squares; in the television version, the point values of the letters can be multiplied at selected intervals). The tiles can appear to move into position or to be carried by animated characters. The movements can be accompanied by appropriate sound effects.

c. an optional program adjusts such factors as the topic on which the quotation and the clues is based and the level of the puzzle's difficulty by consulting a database comprising at least two types of information, namely demographic details about the player (age, gender, geographic region, professed interests, etc.) and the record of that player's prior performance when playing the game.

To solve the puzzle, a player positions the screen pointer, stylus, or similar device in any square of a clue word or any square of the grid. In similar fashion the player then selects from the tray the tile bearing the letter intended for that square. If the letter chosen is incorrect, its point value is substracted from the player's score. If it is correct, it is entered simultaneously in the appropriate square in both the clues and the grid; an animated figure may appear to carry a copy of the tile to its assigned position. In multi-player mode the program will, for each game played, randomly select one letter of the alphabet and designate it as a “Lucky Letter,” which is not revealed to the player(s) until it is selected. A player who enters that letter will receive a bonus of points. As the letters appearing in the grid begin to suggest words, the player can fill in the letters needed to complete those words; these letters simultaneously appear in the clues, thus suggesting words that may not have originally been apparent. The initial letters of the clue words, when read vertically, supply the author of the quote and, in a longer puzzle, the title of the work (abbreviated if necessary) from which it is taken.

LIST OF REFERENCE NUMERALS

| | |
|---|---|
| 1 | Grid |
| 2 | Clues |
| 3 | Clue words |
| 4 | Alphabet tiles with point values. |
| 5 | Score counter |
| 6 | “Word Hint” button |
| 7 | “Letter Hint” button |
| 8 | Optional “More About This Book” button |

### DESCRIPTION—MAIN EMBODIMENT

The puzzle of the invention consists of a display on the screen of a computer, personal digital assistant or similar device which comprises a grid similar to that of a crossword puzzle, a list of clues, spaces for entering the clue words, buttons for “Letter Hint,” “Word Hint,” and “More About This Book,” images of tiles containing the letters of the alphabet with their values before the play begins, and a score counter. In the optional alternative of play as a television game show, the “More About This Book” button can be omitted, and representations of the faces of the players may be added, including one for a player competing remotely.

### OPERATION—MAIN EMBODIMENT

To solve the puzzle of the invention in individual play or in interactive competition, a player must select a word from the clues and enter one or more letters into the appropriate spaces. As those letters are entered, they also appear in the grid as elements of a quotation that will be completed when all or most of the required letters will have been entered into the clues. As the words in the quotation become evident, the player may enter their missing letters directly into the grid and receive double points for each of those letters. Another aid to completing the puzzle of the invention is that the initial letters of the clues, when read vertically, spell the name of the quotation's author (and in the case of a longer quotation, the title of the work from which it was taken).

### DESCRIPTION AND OPERATION—ALTERNATIVE EMBODIMENT

Alternatively, the puzzle of the invention may be played as a competitive television game. In such use, there may be several players, each of whom enters letters according to rules established by the promoters of the television game. The values of the letters may be increased at some predetermined rate for each iteration of the game. When the game is played interactively, one or more contestants outside the studio may participate by means of a home computer, interactive television set or similar means.

### CONCLUSION, RAMIFICATIONS AND SCOPE

The advantages of the puzzle of the invention over previous computer-based acrostic puzzles are that it can be played on personal digital assistants, that it provides for scoring which can be translated into prize money, frequent-flyer miles, or similar inducements to enter a Web site frequently and play the puzzle of the invention. The “More About This Book” button can provide a hyperlink to the Web site of either the publisher of the book, who wishes to sell copies of it, or the vendor of products and/or services associated with the topic of the book, such as gardening, art, or a particular culture. The optional use of visual clues (rather than verbal) permits intriguing associations with art works in museums, plants or flowers, or similar real-world objects that can serve as clues to words in the puzzle of the invention. The optional use of animated characters to carry copies of the tiles into position and the optional use of accompanying sound effects can introduce an element of playfulness that is not found in either the print versions of acrostic puzzles or their present computer-based versions.

[image]

[image]

I claim:

1. An enhanced interactive acrostic puzzle which can be played by one or more players on any of several computers or similar devices, as an interactive television game show, or as an instructional tool.

2. A means for the screen of said devices in claim 1 to display a tray of tiles bearing the letters of the alphabet with their current values and a counter to display the current score when said letters are entered into squares adjacent to clues or into a grid according to clues provided.

3. A means for the value of said letters on said tiles in claim 2 to be increased by a computer program as the game progresses and said letters of claim 2 are entered by said player or players into selected squares to form words in said clues and in said grid.

4. A means for increasing said player's score as said player correctly enters said letters of claim 2.

5. A means for decreasing said score as said player incorrectly enters said letters of claim 2.

6. A means to accompany the movement of said tiles in claim 2 by sound effects.

7. A means to indicate which letters of claim 2 have been selected for particular squares by showing a copy of said tile being carried by an animated figure from its original location to the designated square.

8. A means to replace said clues of claim 2 with visual or musical clues.

9. A means to consult, for each said player in claim 1, a database containing at least two types of information, namely demographic details about said player (such as age, gender, geographic region, professed interests) and the record of said player's prior performance when playing said game, to facilitate such accommodation as the level of play or the choice of subject matter.

10. A means to display, in said television game show mode, on said screen of claim 1, the faces of the contestants, with that of current said player enlarged to occupy a portion of said screen larger than is assigned to the faces of the currently inactive players.

11. A means, in the television game show mode, for said screen of claim 1 to indicate which player has selected a letter by showing a series of icons or cartoons moving from said player's face display to the chosen letter or position.

12. A means, in said television game show mode, for the screen of claim 1 to present a silhouette or other shape to represent a player participating from outside the studio, whose score is computed along with those of the studio players.

13. A means to randomly select and conceal from among said letters of claim 2 a “Lucky Letter,” which can add a bonus to said score of the player who unknowingly selects it.

14. A means to permit competitive play among two or more players, either in proximity or remotely.

14. A means to acquire from remote sources said acrostic puzzles of claim 1 by wireless or other technologies, and to play said game interactively with said sources through computer programs.

15. A means, when said game is played as an instructional tool, to provide pronunciations as said words are formed.
